(19) United States
(12) Patent Application Publication
(10) Pub. No.: US 2002/0152896 A1
(43) Pub. Date: Oct. 24, 2002

(54) Apparatus and system for vending pasta and sauce with powdered sauce

(76) Inventors: Steve Young, Kirkwood, MO (US); Paul Bennett, St. Louis, MO (US)

Correspondence Address: Steven Young, 462 Dickins Avenue, St. Louis, MO, 63122, US

(21) Appl. No.: 09/839,269

(22) Filed: Apr. 19, 2001

(51) Int. Cl. A23L 1/00; A47J 27/00

(52) U.S. Cl. 99/330; 99/331

(57) ABSTRACT

A pasta and sauce vendor including a hopper storing at least one portion of pasta, a pasta cooker for cooking a portion of pasta received from the hopper, a pasta dispenser for dispensing the portion of cooked pasta received from the pasta cooker, at least one container for holding powdered pasta sauce, the container having a dispenser, a water input, a mixer for mixing powdered pasta sauce from the container together with water from the water input, a sauce dispenser for dispensing mixed pasta sauce and a vending circuit whereby a payment is received, and, in response to the receipt of the payment, the pasta is cooked and dispensed and thereafter the sauce is mixed and dispensed.

### CROSS-REFERENCE TO RELATED APPLICATIONS

None.

### STATEMENT REGARDING FEDERALLY SPONSORED RESEARCH OR DEVELOPMENT

Not applicable.

### BACKGROUND OF THE INVENTION

1. Field of the Invention

This invention relates generally to automatic, self-service vending of both pasta and sauce, together with maintenance and supply systems for such vending machines.

2. Related Art

Speed and efficiency of maintenance, service and restocking are critical to the self-service food vending industry. Profitability is directly proportionate to the volume of vending machines serviced by stockmen and servicemen and the efficiency of their route and schedule. Efficient and rapid maintenance and stocking systems are needed for self-service machines to profitably vend types of food that are new to self service vending, like pasta combined with sauce.

Speed and efficiency are increased by decreasing the time necessary for cleaning equipment and restocking food hoppers and dispensers. Shelf life of vending machine food is a limitation that has prevented certain foods, like pasta sauce, from being a profitable item to vend. Moreover, sauce in liquid form must be kept warm by heaters, adding size, complexity and expense to any machine for vending pasta sauce. Finally, sauce in liquid form occupies a large amount of space, which consequently limits the number of different types of sauces that can be dispensed from a single machine.

Rapid pasta cooking for restaurants is known. Reference is made to U.S. Pat. Nos. 5,033,364; 5,010,806; 5,172,627; 5,215,001; all to Narcisi; 5,241,899 and 5,462,210 to Kuhhnan and 4,803,916 to Tacconi. Pasta vending, however, has not had automated sauce vending available for combination with it. Therefore, there is a particular need for self-service vending of pasta and sauce, and to develop efficient, economical and rapid systems and apparatuses for maintenance, service and stocking.

### SUMMARY OF THE INVENTION

The present invention is an apparatus and system for automatic self-service vending of pasta with sauce in a manner that is fast, efficient and economical to maintain, service and stock. The present invention extends re-stocking cycles, conserves space and energy and increases the variety of choices available to a consumer by incorporating powdered pasta sauce.

In a single, preferably countertop, unit, a high speed pasta cooker is activated in response to receipt of a patron's payment by conventional vending methods. Single servings of pasta are dispensed by a modular, preferably plastic, drum, or other type of hopper, to a pasta cooker. A serviceman may rapidly swap an empty pasta-dispensing module for a full one.

The pasta cooker dispenses cooked pasta onto a plate. The patron may then push a button to select a sauce to be immediately dispensed over the pasta. A variety of sauces are stored in the vending machine of the present invention in the form of concentrated powders. When a particular flavor of sauce is selected by the consumer, the powder is mixed with hot water to make the sauce. In one embodiment this mixing is done by the consumer in the pasta bowl itself, by dispensing both powder and hot water into the serving bowl with the hot pasta for the consumer to stir. In an alternative embodiment, powder and hot water are mixed into sauce in a chamber within the vending machine so that mixed, liquid, hot sauce is dispensed onto the cooked pasta.

It is an object of the present invention that space, energy and complexity be conserved within a vending machine apparatus for dispensing pasta sauce by utilizing concentrated sauce powders in a plurality of flavors. Powdered sauces occupy a much smaller area than liquid sauces, and they do not need to be kept warm, since the hot water will warm the sauce upon mixing. It is a further object of the present invention to extend the shelf life of pasta sauces available for vending by using concentrated sauce powders. It is a further object of the system of the present invention to make re-stocking and routing of vending machine servicemen faster and more efficient. It is a further object of the present invention to offer a greater variety of pasta sauces to vending machine consumers.

Further features and advantages of the present invention, as well as the structure and operation of various embodiments of the present invention, are described in detail below with reference to the accompanying drawings.

### BRIEF DESCRIPTION OF THE DRAWINGS

FIG. 1 is a perspective view of a preferred embodiment of the exterior of the pasta and sauce vendor.

FIG. 2 is a front view of the exterior of the pasta and sauce vendor apparatus.

FIG. 3 is a front view of the interior of the pasta and sauce apparatus depicting the pasta cooking and dispensing apparatus.

FIG. 4 is a front view of the interior of the pasta and sauce vendor showing the sauce dispensing apparatus for mixing concentrated sauce powder with water in the vending machine.

FIG. 5 is a front view of the interior of the pasta and sauce vendor showing the concentrated sauce powder dispensing apparatus for mixing with water outside the machine.

### DETAILED DESCRIPTION OF THE PREFERRED EMBODIMENTS

Referring to the accompanying drawings, like reference numbers indicate like elements. In the following detailed description of the preferred embodiments, references are made to the accompanying drawings which form a part hereof, and in which are shown by way of illustration specific embodiments in which the invention may be practiced. It is to be understood that other embodiments may be utilized and structural changes may be made without departing from the scope of the present invention.

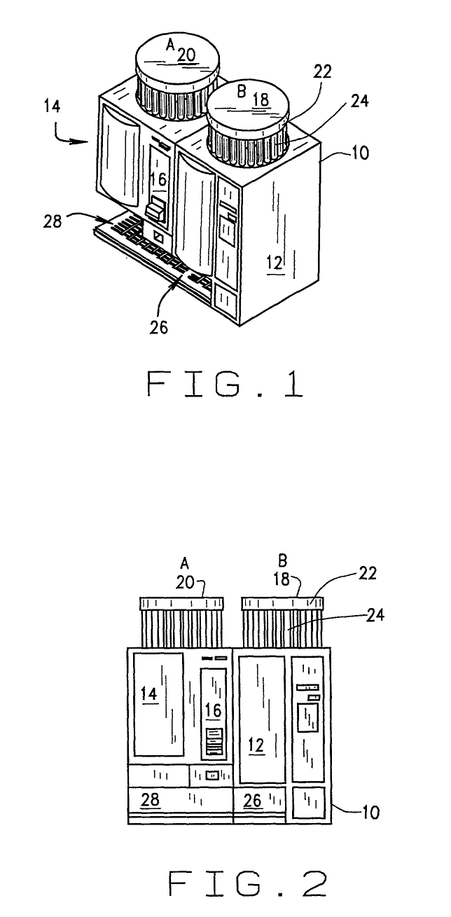

FIGS. 1 and 2 are perspective and front views of the exterior of the pasta and sauce vending apparatus of the present invention. Cabinet, 10, contains an apparatus for cooking and dispensing pasta on the right side, 12, and an apparatus for heating and dispensing sauce on the left side, 14. Operation is initiated in response to payment received by conventional vending machine payment means, 16. Payment means, 16, may include a bill validator, card reader for debit or credit cards, a coin mechanism, or any combination of the above. Each of these components, as well as their combination, are conventional in the vending machine industry. Those of skill in the art will recognize the equivalence of each of these components, and that these components have other equivalents for the purpose of receiving payment and thereafter initiating the vending process.

Pasta storage hoppers, 18 and 20, are disposed on top of the cabinet, 10. Pasta storage hopper, 18, is disposed in operative cooperation with pasta cooking and dispensing apparatus in the cabinet below it, 12, at position B. Pasta storage hopper, 20, is in the storage position A, on the left side of cabinet, 10. In the storage position, the hopper is not in operative communication with any pasta cooking means. In a preferred embodiment, a carriage (not shown) is available to facilitate transferring pasta storage hopper, 20, from a stored position, A, to an operative engagement position, B. Alternatively, and equivalently, a stockman/service man may simply lift pasta storage hopper container, 20, from its storage position, A, and put it in operative engagement position, B, directly. A further equivalent of the present invention is contemplated to be the complete absence of a “spare” pasta storage hopper, 20, at a storage position, A. In this configuration, a stockman/service man would bring replacement pasta storage hoppers, A, with him for placement directly in operative engagement position, B.

Each pasta storage hopper incorporates a lid, 22, and individual portion cylinders, 24. Preferably there are twenty-five cylinders. Upon activation of the pasta cooking apparatus, an individual portion is dispensed from individual cylinder, 24, into the pasta cooking apparatus, described below. In the preferred embodiment, the individual serving of pasta descends by gravity through a through hole (not shown) in cabinet top, 10, below hopper, 18. The hopper is operatively engaged to a moving mechanism (not shown) which repositions, in the preferred embodiment by rotation, the hopper so that the next individual portion of pasta is disposed over the cabinet, 10, through hole (not shown) in a position ready for initiation of cooking that next portion of pasta. Thereby a next patron executing a next vend order will receive the next sequential individual serving of pasta from the next sequential individual serving storage cylinder.

After the pasta is cooked, it is dispensed onto a plate (not shown) placed in receiving station, 26.

Thereafter, the patron moves his or her plate of pasta to sauce receiving station, 28. The patron pushes a button (not shown) to activate the dispensing of sauce on top of the pasta.

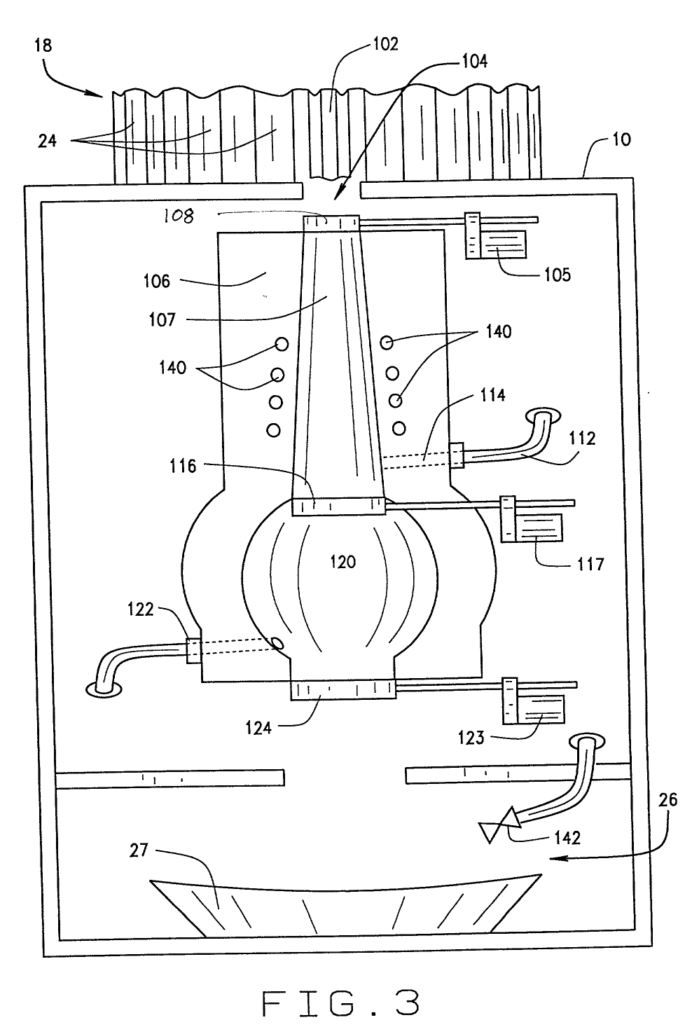

FIG. 3 depicts the pasta cooking and dispensing apparatus contained within the right (equivalently, left) side, 12, of cabinet, 10. Individual portions of pasta, 102, are held within the individual serving cylinders, 24. Pasta storage hopper, 18, preferably a drum, is moved, preferably rotated, so that an individual portion of pasta, 102 is disposed above a through hole/pasta conduit, 104. Upon receipt of a patron's payment, a relay (not shown) activates a mechanism, 105, for example, to open a trap door or gate, 108, to allow an individual portion of pasta, 102, to proceed through conduit, 104, into pasta cooking container, 106 having a chamber, 107. In a preferred embodiment, the progress of pasta through cooking and dispensing stages is by gravity. It is contemplated that equivalent means of propelling pasta through the cooking and dispensing apparatus is within the scope of this invention, including but not limited to mechanical means or pressure means.

The sequential execution of process steps by the apparatus of the present invention is preferably by means of conventional electrical relays. It is contemplated to be within the scope of this invention that other system control means may be used, such as programmable logic circuits or software controlled processing. Appropriate systems controls are well known to those of skill in the art.

Upon receipt of the pasta, 102, within the pasta cooking chamber, 107, gate, 108, closes behind the pasta. Water is received into pasta cooking chamber, 107, through conduit, 112, by means of opening valve, 114. Water is received from any source, preferably through a standard plumbing connection to a building water supply. Equivalently, water may be stored or pre-heated in an auxiliary tank (not shown) and/or an annular chamber (not shown) incorporated to the cooker housing, 106.

The sealed cooking chamber is then heated by elements, 140. Some moderate amount of pressure is created, but the water is not under any pressure before entering the cooking chamber. A pre-programmed timer (not shown) determines when the pasta has reached the desired cooked texture through being pre-programmed with data correlating time, temperature and desired texture. Preferably, the timer may be adjusted by a serviceman at the machine, or by a connection to remote control, as through the Internet. It is anticipated, but not required, that the apparatus of the present invention will cook pastas in about 2 minutes, total. In the preferred embodiment, the pasta is cooked in the first cooking chamber for about one minute.

Upon completion of its period, the timer actuates a motor, 117, to open the lower pasta cooking chamber valve or gate, 116, to allow egress of the pasta, 102, and hot water from the first pasta cooking chamber to a second cooking chamber, 120. In the second chamber, 120, the pasta finishes cooking at atmospheric pressure. Cooking is competed by the still hot water from first cooking chamber, 107.

A second timer, or, equivalently, the same timer or a programmable logic circuit, actuate a valve, 122, to drain the hot cooking water. Then motor, 123, opens a lower second cooking chamber valve, 124, upon completion of the entire cooking cycle. Gate, 124, thereby acts as a cooked pasta dispenser. Nozzle, 142, sprays fresh water onto a plate, 27, to prevent the pasta from sticking. Thereafter, the now cooked pasta descends, preferably by gravity, through second cooking chamber exit gate, 124, and onto a plate, 26, which the patron has placed in pasta receiving station, 26.

A pasta cooking apparatus consistent with a preferred embodiment includes features not depicted in FIG. 3, including an unpressurized water staging tank, an unpressurized hot water pre-heating chamber in an annular configuration around first pasta cooking chamber, 107, and insulation. Automated control systems consistent with this most preferred embodiment are well known to those of skill in the art and need not be disclosed in greater detail here.

In a preferred embodiment the pasta cooker receives, cooks and dispenses a portion of pasta in approximately two minutes or slightly longer. No cooking chamber uses augmented, increased pressure, although sealing the first cooking chamber will result in consequential pressure increases not exceeding three bar.

It is further contemplated to be within the scope of the present invention that other pasta cooking devices may be incorporated into the pasta and sauce vending apparatus of the present invention. Hence, alternative embodiments may incorporate any of number of pasta cookers including cookers designed to produce hot pasta in less than two minutes, pasta cookers designed to cook at higher pressures, pasta cookers designed to cook at a pressure greater than three bar in at least one chamber and including, without limitation, such pasta cookers as are disclosed in U.S. Pat. Nos. 5,033,364; 5,010,806; 5,172,627; and 5,215,011, to Narcisi, which are incorporated herein by reference.

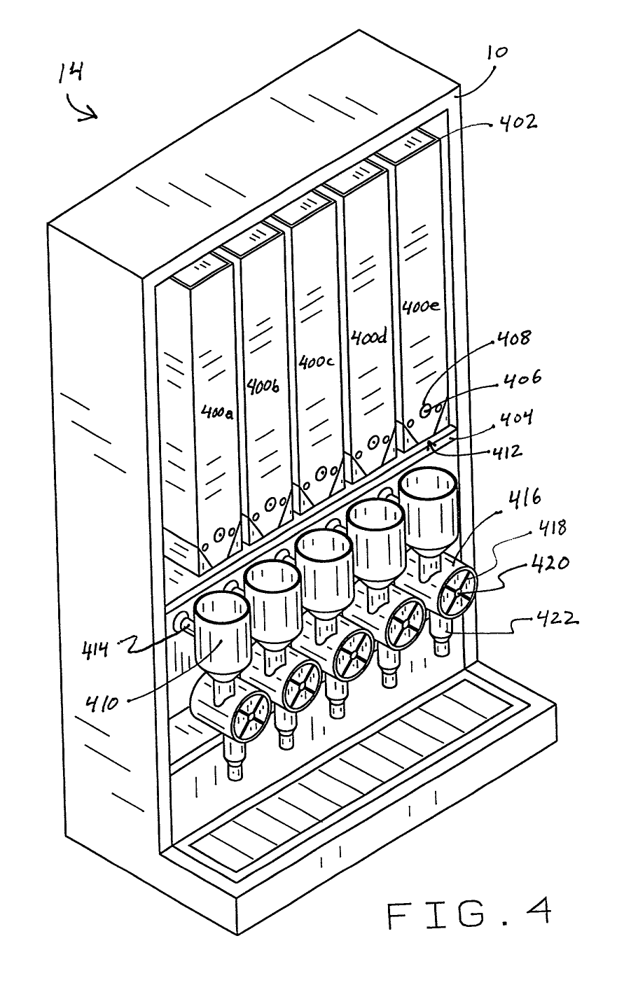

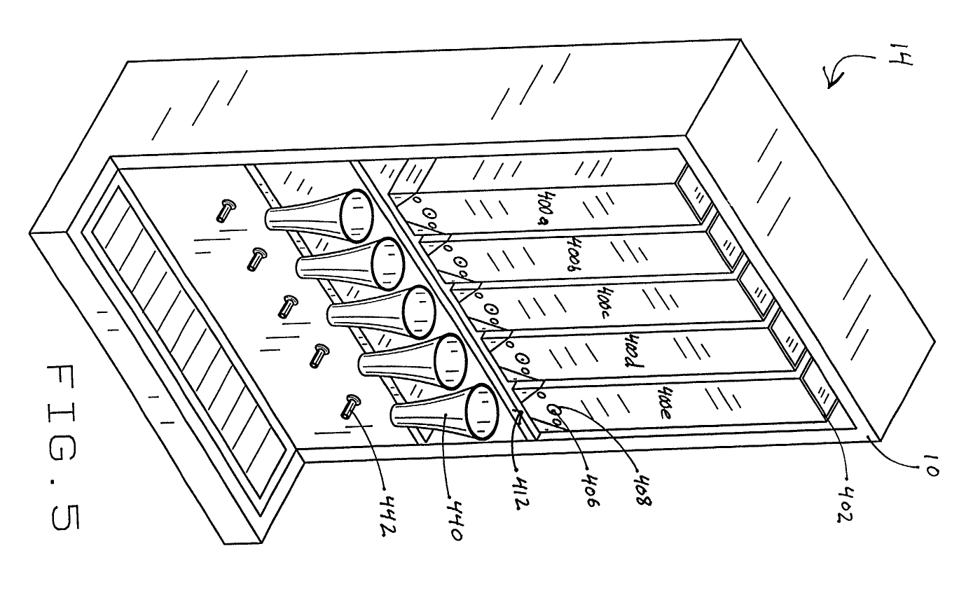

FIGS. 4 and 5 depict alternative embodiments of the sauce dispensing apparatus housed within the cabinet side, 14 and supported by various attachments to cabinet frame, 10. The attached pasta cooker within another compartment of the housing, is not shown. Both embodiments mix concentrated pasta sauce powder with water, preferably hot water, to make fluid pasta sauce.

FIG. 4 depicts one embodiment that mixes concentrated pasta sauce powder with water inside the vending machine. A front cover, lid, housing panel or the like is not shown and would cover the depicted components during operation. A plurality of concentrated pasta sauce powders, 400a, 400b, 400c, 400d, and 400e, are stored in a plurality of powder containers, here depicted as bins, 402. It is contemplated to be within the scope of the present invention that any practical number of different sauce variety powders may be made available for vending with any practical number of bins and other components. Bins may be disposable or refillable through a resealable top opening (not shown). Bins may be made of any suitable material, but are preferably plastic. Bins may be accessed for restocking through any conventional means, but preferably slide out of retaining slots defined either by dividers (not shown) or adjacent bins dimensioned to closely cooperate in order to retain the bins in operative position. Bins rest on a support floor, 404.

Equivalently, any conventional container of any suitable material may hold the powdered sauces. Preferably, each bin has an auger (not shown) rotatable around an auger axis, 406. Each auger is housed within an auger housing cylinder, 408. Auger axis, 406 and auger housing cylinder, 408, all extend perpendicularly to the plane of the page of FIG. 4 and into the bin, 402. The housing, 408, has an opening (not shown) allowing powder, 400, within the bin to communicate with the auger.

When a consumer pushes one of the plurality of buttons (not shown) on a front cover (not shown) of cabinet, 10, a relay closes activating one of the plurality of stepper motors (not shown) corresponding to the bin containing the flavor of sauce powder selected by the consumer. The motor turns the auger via the auger axis, 406. The volume of powder corresponding to a single serving is pre-determined, and this volume in turn correlated to a number of auger turns. The stepper motor is programmable via any of a variety of conventional means such as software or programmable logic circuits to turn the auger a pre-determined amount corresponding to the known volume of powder comprising a single serving. The turning auger carries the powder forward out of the plane of the page. Auger housing, 408, extends a small distance out of the plane of the page as well, beyond the front wall of the bin, 402, such that it is disposed over receiving funnel, 410. The auger housing extension, 408, has an exit opening, 412, which allows the powder being carried forward by the auger to fall out of the housing and into the receiving funnel, 410.

Equivalently, any powder dispensing means from the powdered sauce container is considered to be within the scope of the present invention, including, without limitation, gates, valves, chutes or combinations thereof.

As powder, 400, drops into the funnel, 410, a relay also having been closed by the consumer's push button flavor selection activates a water jet, 414, to dispense hot water into funnel, 410. Preferably the water is impelled by building water pressure, although a pressurized boiler, with or without a pump, is also within the scope of the present invention. Jet, 414, propels the hot water tangentially around the interior circumference of funnel, 410, directly mixing the falling powder with the water. Also, the jet of water may create a venturi effect further drawing powder into the mix.

Funnel, 410, is in fluid communication with mixing chamber housing, 416, such that the water-powder mix drops by gravity into mixing chamber, 416. Within mixing chamber, 416, paddle wheels, 418, turn on axis, 420, in order to complete mixing of the powder, 400, and water. The paddle wheels, 418, serve to break up any lumps of powder. Mixing chamber, 416, is in fluid communication with dispensing nozzle, 422, such that fluid sauce, now completely mixed, descends by gravity into sauce receiving station, 28, on top of a plate of cooked pasta put there by the consumer.

It is considered to be within the scope of this invention that any means of mixing concentrated pasta sauce powder with water may be employed.

FIG. 5 depicts an alternative embodiment of the present invention wherein powder and hot water are mixed to make sauce outside of the vending machine, on the plate of hot pasta by having the consumer stir the powder and water together.

As with the previous embodiment, powders comprising a concentrate of various flavors of sauce, 400a, 400b, 400c, 400d and 400e are contained within bins, 402. As in the previous embodiment, stepper motors (not shown) are activated in response to a consumer pressing a button corresponding to the flavor the consumer selects. Also as in the previous embodiment, the stepper motor turns the auger (not shown) around auger axis, 406, a number of degrees of rotation corresponding to a pre-determined volume of powder corresponding to a single serving. The auger moves powder forward in auger housing, 408, until the powder reaches the auger housing, 408, exit opening, 412.

In the present alternative embodiment, the powder, 400, falls into funnel, 440, and 5 through it descends directly onto a plate of hot pasta placed under the funnel in the pasta receiving station by the consumer. The concentrated sauce powder falls onto the hot pasta still in powder form. Hot water is sprayed by nozzle, 442, directly onto the plate of hot pasta with the powder. As before, hot water may simply originate with the building water supply, or may be augmented by a heater, boiler and/or pump, any combination of which is contemplated to be within the scope of the present invention. Now having a plate of hot pasta with powder and hot water in it, the consumer stirs the same together, mixing the powder and hot water until they combine to form a fluid sauce. Any utensil may be used to stir and be within the scope of the present invention.

It is contemplated to be within the scope of the present invention that all of the components recited above, including but not limited to the bins, 402, auger, auger housing, 408, auger housing exit opening, 412, direct funnel, 440, or, alternatively, funnel, 410, in combination with mixing chamber, 416, and paddle wheels, 420, and dispensing spout, 422, may be of sufficiently large bore and dimension to accommodate powders including large particles of food, such as, by way of example and not limitation, mushrooms, black olives or the like, in dehydrated or other forms.

In view of the foregoing, it will be seen that the several advantages of the invention are achieved and attained.

The embodiments were chosen and described in order to best explain the principles of the invention and its practicable application to thereby enable others skilled in the art to best utilize the invention and various embodiments and with various modifications as are suited to the particular use contemplated.

It is contemplated that the present invention may cook, dispense and vend similar food products and still be within the scope of and equivalent to the present invention, as, by way of example and not by limitation, chinese noodles and sauce, rice and sauce or the like.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above described exemplary embodiments, but should be defined only in accordance with the following claims appended hereto and their equivalents.

We claim:

1. A pasta and sauce vendor comprising:
a hopper storing at least one portion of pasta;
a pasta cooker for cooking a portion of pasta received from said hopper;
a pasta dispenser for dispensing the portion of cooked pasta received from said pasta cooker;
at least one container for holding powdered pasta sauce, said container having a dispenser;
a water input;
a mixer for mixing powdered pasta sauce from said container together with water from said water input;
a sauce dispenser for dispensing mixed pasta sauce; and
a vending circuit whereby a payment is received, and, in response to the receipt of the payment, the pasta is cooked and dispensed and thereafter the sauce is mixed and dispensed.

2. The pasta and sauce vendor of claim 1 wherein said vendor cooks and dispenses food materials other than pasta and sauce.

3. A pasta and sauce vendor comprising:
a vending circuit for receiving payment and in response to the payment initiating pasta and sauce vending;
a hopper storing at least one portion of pasta;
a pasta cooker for cooking a portion of pasta received from said hopper;
a pasta dispenser for dispensing the portion of cooked pasta received from said pasta cooker;
at least one container for holding powdered pasta sauce, said container having a dispenser; and
a water source;
whereby the powdered pasta sauce may be dispensed onto a plate of cooked pasta and the water may be dispensed onto the plate of cooked pasta, there to be mixed together by a consumer to create fluid pasta sauce.

4. The pasta and sauce vendor of claim 3 wherein said vendor cooks and dispenses food materials other than pasta and sauce.

5. A pasta and sauce vendor comprising:
a housing having a through hole for receiving uncooked portions of pasta, a cooked pasta receiving station, and a pasta sauce container access;
a vending circuit whereby a payment is received, and, in response to the receipt of the payment, a portion of pasta is cooked and dispensed and thereafter a portion of sauce is mixed and dispensed;
a hopper removeably affixed to said housing storing a plurality of portions of pasta and moveable to dispose individual portions of pasta into communication with the through hole of said housing;
a pasta cooker fixedly attached within said housing and in communication with the through hole of said housing for receiving an individual portion of uncooked pasta from said hopper, said cooker having a top gate that opens to receive the portion of pasta and closes to cook the portion of pasta and having a bottom gate for dispensing the portion of pasta when cooked into the cooked pasta receiving station of said housing;
at lease one pasta sauce powder container removeably disposed within said housing, said container having a dispenser;
a water input;
a mixer for mixing powdered pasta sauce from said container together with water from said water input;
a sauce dispenser for dispensing mixed pasta sauce; and
whereby said pasta hopper may be replaced when empty and the sauce powder container access of said housing opens to allow access to said at least one pasta sauce container for restocking with pasta sauce powder to allow a next cycle of vending.

6. The pasta and sauce vendor of claim 5 wherein said vendor cooks and dispenses food materials other than pasta and sauce.

7. The pasta and sauce vendor of claim 5 wherein said mixer is a utensil stirred by a consumer.

8. A method of maintaining a pasta and sauce vendor comprising:
stocking a hopper with portions of pasta;
loading the hopper into operative disposition with said pasta and sauce vendor such that the portions of pasta may be received by a pasta cooker within said pasta and sauce vendor for cooking;
stocking at least one bin with pasta sauce powder; and
loading the pasta sauce powder bin into operative disposition within said pasta and sauce vendor.

9. The method of maintaining a pasta and sauce vendor of claim 8 wherein said vendor cooks and dispenses food materials other than pasta and sauce.

10. A method of vending pasta and sauce comprising:
stocking a hopper with portions of pasta;
loading the hopper into operative disposition with a pasta and sauce vendor such that the portions of pasta may be received by a pasta cooker within the pasta and sauce vendor for cooking;
stocking at least one bin with pasta sauce powder;
loading the pasta sauce powder bin into operative disposition within said pasta and sauce vendor.
receiving payment from a consumer, and in automated response to said payment receipt;
intaking a portion of pasta from the hopper into the pasta cooker;
cooking the pasta;
dispensing the pasta;
mixing pasta sauce powder with water to make fluid pasta sauce in response to a consumer initiating sauce mixing with a sauce mixing actuator; and
dispensing the sauce.

11. The method of vending pasta and sauce of claim 10 wherein said vendor cooks and dispenses food materials other than pasta and sauce.

12. The method of vending pasta and sauce of claim 10 wherein said sauce mixing and sauce dispensing steps are comprised of:
dispensing pasta sauce powder onto cooked pasta;
dispensing water onto the cooked pasta;
whereby the consumer mixes the pasta sauce powder together with the water to make sauce.

13. The method of vending pasta and sauce of claim 12 wherein said vendor cooks and dispenses food materials other than pasta and sauce.
